(19) United States
(12) Patent Application Publication
(10) Pub. No.: US 2015/0367350 A1
(43) Pub. Date: Dec. 24, 2015

(54) GRANULES CONDITIONER

(71) Applicant: MASCHINENFABRIK GUSTAV EIRICH GMBH & CO. KG, Hardheim, Deutschland (DE)

(72) Inventors: Stefan MÜNKEL, Kulsheim (DE); Andreas SEILER, Tauberbischofsheim (DE); Stefan GERL, Werbach (DE)

(21) Appl. No.: 14/765,279

(22) PCT Filed: Mar. 18, 2014
(86) PCT No.: PCT/EP2014/055384

§ 371 Date: Jul. 31, 2015

(30) Foreign Application Priority Data
Mar. 25, 2013 (DE) 10 2013 103 012.2

(51) Int. Cl. B02C 7/11; B02C 23/02; B02C 7/08

(52) U.S. Cl. CPC B02C 7/11; B02C 7/08; B02C 23/02

(57) ABSTRACT

The present invention concerns a granular material conditioner for optimising grain sizes of granular materials comprising two discs which are rotatable relative to each other and which are arranged in substantially mutually parallel relationship, a granular material inlet through which granular material can be passed into the conditioner into an annular gap between the two discs, and a catch container for receiving the granular material which issues from the gap between the two discs by virtue of centrifugal force. According to the invention it is proposed that the catch container has an elastic curtain, wherein the curtain is spaced at least portion-wise from the catch container wall and limits the trajectory of the granular material issuing from the gap.

The present invention concerns a granular material conditioner for optimising grain sizes of granular materials.

Particularly in technical ceramics ceramic granular materials with a high degree of pourability are required. Therefore the grain sizes should lie within a predetermined grain size range. Both granular material proportions with excessively large grain sizes and also those with excessively small grain sizes are frequency unwanted.

The process for the production of granular materials in technical ceramics, which is to be most frequency encountered, is spray drying. For that purpose fine powders are mixed with liquid to constitute a suspension. That is then granulated in a spray dryer, that is to say the suspension is atomised by way of a nozzle system or centrifugal discs in a hot atmosphere. The resulting droplets are dried in the drying room by hot air which is passed in counter-flow relationship with the droplets. The particles contained in the droplets agglomerate together and form granular materials. The residual moisture and the granular material size distribution can be influenced inter alia on the basis of the nozzle geometry. The advantage of that process which has been established for decades lies in the high granular material yield in the range of 100-800 μm. The disadvantage lies in the large amount of liquid which is necessary for the spray operation and which first has to be fed to the solids and which then has to be almost completely dried out again.

An alternative process for the production of granular materials is so-called growth agglomeration. There the starting materials are fed in the form of powder particles to a mixer. After the addition of water and possibly organic binders agglomerates or granular materials are formed by the mixing movement.

Growth agglomeration is economically markedly more advantageous but results in a worse grain size distribution as large granules form very quickly with diameters markedly above 1000 μm. The granular material therefore has to be processed.

Granular material conditioners are known for example from EP 1 070 543, with which the grain sizes of granular materials can be reduced. They have an element which is rotatable relative to a stationary housing, the rotatable element having portions in the shape of the surface of a cone. Between the portions in the shape of the surface of a cone and the stationary housing is a gap which extends conically in cross-section, by virtue of the differing cone angles. The granular material particles to be processed are passed through the gap and comminuted thereby. The exit gap is arranged very close to the housing wall.

When using granular materials for technical ceramics and in particular in relation to granular materials which were produced by means of growth agglomeration and which therefore generally involve a moisture content of between 10 and 15% immediately after production, it frequently happens in the granular material conditioners, in particular in the ejection zone and at the stationary housing, that large agglomerates and lumps adhere together and are re-formed, and such agglomerates and lumps severely adversely affect the quality of the optimised granular material.

Disc mills are also known, which use two discs which are rotatable relative to each other and which are arranged in substantially mutually parallel relationship, with a tooth arrangement on the top side, wherein the material to be ground is introduced into a substantially annular gap between the two discs. Due to the relative rotary movement, in which case generally one of the two discs is stationary while the other disc rotates about its disc axis, the material to be ground is ground in the gap by the shearing action at the teeth. Such disc mills cannot be used for conditioning growth agglomerates or granular materials as the spaces between the teeth are gummed up by the moisture and the particles and the mill is clogged. Typical areas of use of those types of mill are grinding dry mineral raw materials, plastic materials or paper suspensions.

The use of those machines is also not possible for granular materials for technical ceramics and in particular for granular materials which were produced by means of growth agglomeration and which therefore generally have a freely moveable moisture of between 10 and 15% immediately after production.

The two discs of the disc mills are arranged within a housing which generally closely embraces the discs, for receiving the material which issues from the gap between the two discs by virtue of centrifugal force. In other words the starting components are ground by the relative movement of the two discs in the gap between the two discs and are flung outwardly by virtue of centrifugal force so that they impinge against the wall of the catch container. If such a disc mill were used for the processing of granular materials then the granular material issuing from the grinding discs would remain adhering to the rigid wall of the housing, which as the end result means that the granular material grains form lumps so that the quality of the granular material leaving the disc mill is worsened again.

Starting from the described state of the art therefore the object of the present invention is to provide a granular material conditioner with which granular materials which have been produced with a granulating mixer from fine powders with the addition of a liquid and which have a moisture content in the range of about 10 to 15% can be processed.

According to the invention that object is attained by a granular material conditioner which is of a similar structure to a disc mill, that is to say comprising two discs which are rotatable relative to each other and which are arranged in substantially mutually parallel relationship, a granular material inlet through which granular material can be passed into the conditioner into an annular gap between the two discs, and a catch container for receiving the granular material which issues from the gap between the two discs by virtue of centrifugal force. It will be noted however that the catch container has an elastic curtain, which is spaced at least portion-wise from the catch container wall and is so arranged that it limits the trajectory of the granular material issuing from the gap.

In other words an elastic material is suspended in the catch container in such a way that the granular materials issuing from the annular gap by virtue of the centrifugal force impact against the elastic curtain. Because the curtain is at a certain spacing relative to the catch container wall it can correspondingly move whereby the probability of the granular material adhering to the elastic curtain is markedly reduced. In principle the elastic curtain can be formed from any elastic material, in particular from any polymer material, in particular from any elastomer. The elastic curtain particularly preferably comprises polyurethane.

In a preferred embodiment the elastic curtain is arranged completely surrounding the pair of discs. That has the advantage that granular material issuing substantially over the entire disc periphery impinges on the elastic curtain and from there generally drops without adhering into the catch container.

It has been found that the curtain is advantageously of a bell-shaped configuration. In that case the curtain adjoins one of the two discs as far as possible over the entire periphery.

In that respect in a preferred embodiment the form of the elastic curtain is such that the elastic curtain includes an angle of between 15° and 75°, preferably between 25° and 65° and best between 35° and 45° with a notional radial prolongation of the annular gap. The result of this is that the granular material balls issuing from the annular gap impact against the elastic curtain substantially at the same angle.

More specifically it has been found that an excessively large impact angle cannot prevent the granular material from adhering to the elastic curtain. With an excessively small impact angle the catch container has to be markedly larger, which increases the costs for the granular material conditioner without this being linked to an additional benefit.

In a preferred embodiment the elastic curtain is of an S-shaped cross-section, that is to say it has a concave region closer to the gap and a convex region adjoining the concave region. Preferably a notional radial prolongation of the annular gap intersects the elastic curtain substantially in the proximity of the connection between the concave region and the convex region.

It has further been found that the elastic curtain is substantially smooth at least at the side towards the gap, that is to say it has neither knobs, grooves nor ribs. In a further preferred embodiment both discs are rotatable about their disc axis. It has been found that this measure avoids the possibly moist granular material becoming stuck and clogged between the discs, that is to say within the annular gap. If both discs rotate they must be driven at differing speeds. The direction of rotation of the rotating discs can in that case be either the same direction or the opposite direction.

In a preferred embodiment a disc has a central opening, by way of which the granular material can be supplied. For example the disc which has the central opening can be drivable with a hollow shaft, through which the granular material can be fed into the gap by way of the central opening.

For example the two discs can be oriented horizontally. In that case the upper disc should have the central opening, by way of which the granular material can be fed into the gap by means of the force of gravity.

To be able to adjust the granular material size a preferred embodiment provides a device for adjusting the gap width. In a particularly preferred embodiment the adjustable disc is mounted adjustably by way of three mounting points so that, besides the gap width, it is also possible to adjust the parallelism of the discs relative to each other by individual adjustment of the mounting points.

If nonetheless the granular material should become stuck fast and clogged in the annular gap, a preferred embodiment provides a pivot device, by means of which a disc, preferably the upper disc, can be pivoted about a pivot axis extending parallel to the plane of the gap to ensure access to the gap. The clinging material can then be removed and the conditioner is ready for use again.

It is further advantageous if the discs are substantially flat at their surfaces forming the gap. Because the discs do not have any tooth arrangement the risk of deposits is further reduced.

In a further particularly preferred embodiment the granular material conditioner is arranged in the same housing as a granulating mixer. The two components together form an apparatus for the production of an optimised granular material.

Further advantages, features and possible uses of the present invention will be apparent from the following description of a preferred embodiment and the accompanying Figures in which:

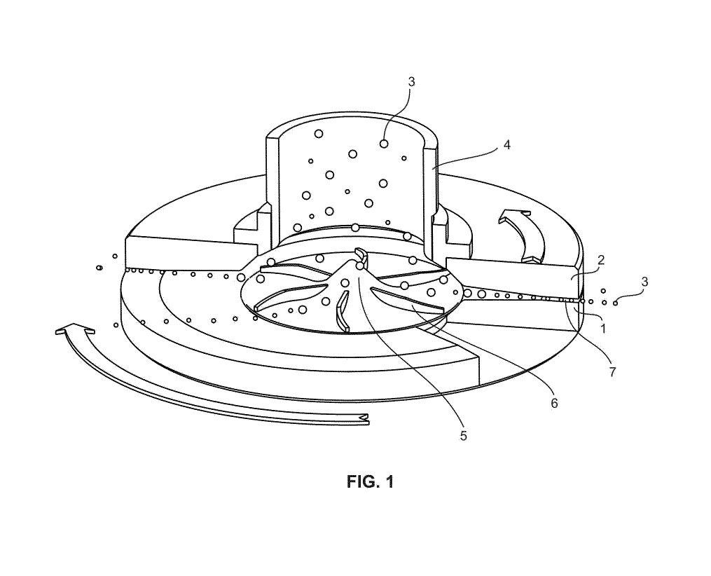

FIG. 1 is a diagrammatic view of the operating principle of the conditioning device, and

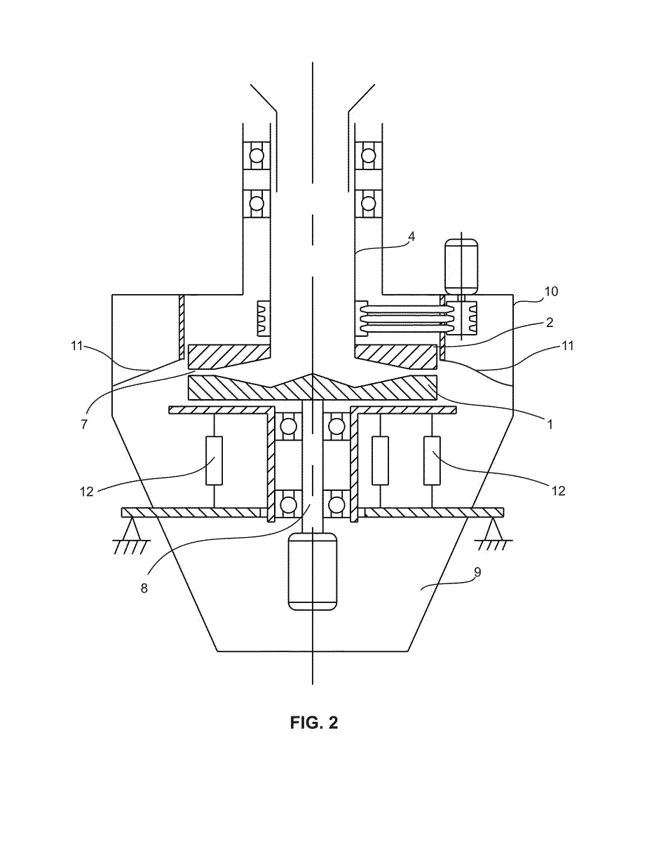

FIG. 2 shows a sectional view through a part of a conditioner according to the invention.

FIG. 1 diagrammatically shows the operating principle of the conditioner according to the invention. The conditioner has two rotating discs 1, 2 which are driven in such a way that they rotate relative to each other. In the illustrated example the two discs are driven in different directions. An annular gap 7 remains between the two discs. The upper disc 2 is driven by means of a hollow shaft 4 through which granular material to be optimised can be fed. The lower disc 1 has at the centre a central cone 5 and a row of vanes 6. The granular material which is passed by way of the hollow shaft 4 between the discs under the effect of the force of gravity is moved radially outwardly by the cone 5 and the vanes 6 so that it is transported into the annular gap 7 by virtue of the radial acceleration. In the gap the granular material is comminuted until it issues again from the annular gap 7 at the periphery thereof.

It will be seen that the annular gap 7 has a conically converging portion which is arranged radially further inwardly and a portion in which the gap remains substantially constant and which adjoins the conically converging portion so that it is arranged radially further outwardly.

The granular material is comminuted in the conically converging portion so that the granular material can be subsequently rolled in the radially outwardly adjoining gap portion of a substantially constant gap width. As an alternative thereto it would also be possible to provide a plurality of conically converging portions.

The discs shown in FIG. 1 are usually mounted in a catch container.

FIG. 2 shows an embodiment of the invention. The conditioner is shown here as a sectional view. As far as possible the same references are used as those in FIG. 1. Here too the granular material can be supplied by way of the hollow shaft 4. The lower disc 1 is driven by way of the shaft 8 while the upper disc 2 is driven by way of the hollow shaft 4. The granular material is comminuted in the annular gap 7 and radially accelerated by the rotating discs so that it issues from the annular gap 7 at the periphery at a not inconsiderable speed. In the known conditioners the issuing granular material impacts against the housing wall which closely surrounds the ejection gap and is conveyed from there in the direction of the granular material discharge for example by means of rotating clearing-out fingers.

Particularly when the granular material is of average moisture content it can however happen that the granular material issuing from the annular gap 7 at high speed adheres to the housing wall so that accumulations of granular material form there, which can then uncontrolledly detach from the wall. The pieces which become detached comprise small grains of granular material which adhere to each other and which cannot be used for further processing.

Therefore the conditioner according to the invention has an elastic curtain 11 so arranged that the granular material grains issuing from the annular gap 7 firstly hit the elastic curtain 11. The elastic curtain 11 which is of a bell-shaped configuration in the preferred embodiment is arranged spaced relative to the wall of the catch container 10 so that, upon impact of granular materials, it is caused to oscillate, which provides that the probability of granular material remaining clinging to the elastic curtain is markedly reduced. Nonetheless the possibility of individual grains of granular material adhering to the curtain can also not be excluded here. Therefore the curtain is so arranged that the grains issuing from the annular gap meet the elastic curtain 11 substantially at an impact angle of about 40 to 50 degrees. That has the advantage that a grain of granular material which is already adhering to the elastic curtain 11 is not pressed against the elastic curtain by the impact of a further grain, but is displaced thereon by the impact thereon of the following particle, which generally has the effect that the grain adhering to the curtain is detached and dropped into the catch container 9.

In the particularly preferred embodiment the elastic curtain is of a substantially S-shaped configuration in cross-section, that is to say it has a concave region and an adjoining convex region, wherein the concave region is arranged closer to the annular gap 7. In that respect the curtain 11 is so arranged that the granular material issuing from the gap meets the curtain substantially in the proximity of the connection between the concave region and the convex region.

To be able to adjust the size of the granular material by altering the width of the annular gap 7 one of the rotating discs 1 or 2 is mounted adjustably in height. Height adjustment of the gap 12 can be effected by way of a mounting point or by way of a plurality of and preferably three mounting points so that, besides the gap width, it is also possible to adjust the parallelism of the discs relative to each other by individual adjustment of the mounting points.

The peripheral speed of at least one disc should be more than 10 m/s and preferably more than 20 m/s. When the discs are driven the one disc should involve a peripheral speed which is at least 10% greater than the peripheral speed of the other disc.

### LIST OF REFERENCES

1 lower disc
2 upper disc
3 granular material
4 hollow shaft
5 cone
6 vanes
7 annular gap
8 shaft
9 catch container
10 catch container wall
11 curtain
12 gap height adjustment

1. A granular material conditioner for optimising grain sizes of granular materials comprising two discs which are rotatable relative to each other and which are arranged in substantially mutually parallel relationship, a granular material inlet through which granular material can be passed into the conditioner into an annular gap between the two discs, and a catch container for receiving the granular material which issues from the gap between the two discs by virtue of centrifugal force, characterised in that the catch container has an elastic curtain, wherein the curtain is spaced at least portion-wise from the catch container wall and limits the trajectory of the granular material issuing from the gap.

2. A granular material conditioner according to claim 1 characterised in that the elastic curtain is arranged completely surrounding the pair of discs.

3. A granular material conditioner according to claim 2 characterised in that the curtain is of a bell-shaped configuration.

4. A granular material conditioner according to claim 1 characterised in that the elastic curtain includes an angle of between 15° and 75°, preferably between 25° and 65° and best between 35° and 55° with a notional radial prolongation of the annular gap.

5. A granular material conditioner according to claim 1 characterised in that the elastic curtain has a S-shaped cross-section, that is to say a concave region closer to the gap and a convex region adjoining the concave region, wherein preferably a notional radial prolongation of the annular gap intersects the elastic curtain substantially in the proximity of the connection between the concave region and the convex region.

6. A granular material conditioner according to claim 1 characterised in that the elastic curtain is substantially flat at the side towards the gap, that is to say it is without knobs, grooves or ribs.

7. A granular material conditioner according to claim 1 characterised in that both discs are rotatable about their disc axis.

8. A granular material conditioner according to claim 1 characterised in that a disc has a central opening, by way of which the granular material can be supplied.

9. A granular material conditioner according to claim 8 characterised in that the disc which has the central opening is drivable with a hollow shaft, through which the granular material can be fed into the gap by way of the central opening.

10. A granular material conditioner according to claim 1 characterised in that there is provided a device for adjusting the gap width.

11. A granular material conditioner according to claim 1 characterised in that the two discs are oriented horizontally.

12. A granular material conditioner according to claim 1 characterised in that the annular gap has one or more portions which are conical in cross-section.

13. A granular material conditioner according to claim 1 characterised in that at least one disc is driven at a peripheral speed of more than 10 m/s.

14. A granular material conditioner according to claim 1 characterised in that the discs are substantially flat at their surfaces forming the gap.

15. Apparatus for the production of an optimised granular material comprising a housing in which there are arranged a granulating mixer for producing a granular material from powders and possibly liquid and a granular material conditioner according to claim 1.

16. A granular material conditioner according to claim 10, wherein the device is so adapted that the parallelism of the discs relative to each other can be adjusted therewith.

17. A granular material conditioner according to claim 11 wherein there is provided a pivoting device, by means of which a disc, can be pivoted about a pivot axis which extends parallel to the plane of the gap.

18. A granular material conditioner according to claim 17, wherein the disc is the upper disc.

19. A granular material conditioner according to claim 13 wherein when both discs are driven the peripheral speeds of the two discs are different.

20. A granular material conditioner according to claim 19 the peripheral speed of the one disc is at least 10% greater than the peripheral speed of the other disc.
